(19) United States
(12) Patent Application Publication
(10) Pub. No.: US 2020/0255722 A1
(43) Pub. Date: Aug. 13, 2020

(54) SELF-CONSOLIDATING MICRO-PROPPANT FOR HYDRAULIC FRACTURING APPLICATIONS

(71) Applicant: Halliburton Energy Services, Inc., Houston, TX (US)

(72) Inventors: Mallikarjuna Shroff Rama, Houston, TX (US); Rajender Salla, Houston, TX (US); Monica Rajendra Dandawate, Houston, TX (US); Philip D. Nguyen, Houston, TX (US)

(73) Assignee: Halliburton Energy Services, Inc., Houston, TX (US)

(21) Appl. No.: 15/776,377

(22) PCT Filed: Dec. 29, 2015
(86) PCT No.: PCT/US15/67807

§ 371 Date: May 15, 2018

(51) Int. Cl. C09K 8/80; C09K 8/92; E21B 43/267

(52) U.S. Cl. CPC C09K 8/80; E21B 43/267; C09K 8/805; C09K 8/92

(57) ABSTRACT

A well treatment method includes placing a first stream comprising a base fluid, a first micro-proppant, and a second micro-proppant into a zone in a subterranean formation comprising microfractures, wherein the first micro-proppant comprises at least one functional group selected from amino groups, mercapto groups, carboxylates, vinyls, and combinations thereof, wherein the second micro-proppant comprises at least one functional group selected from acrylates, epoxies, isocyanates, oxazolines, vinyls, and combinations thereof; and allowing the first and second micro-proppants to self-consolidate. A micro-proppant composition includes a first micro-proppant comprising at least one functional group selected from amino groups, mercapto groups, carboxylates, vinyls, and combinations thereof; and a second micro-proppant comprising at least one functional group selected from acrylates, epoxies, isocyanates, oxazolines, vinyls, and combinations thereof.

### BACKGROUND

The present invention generally relates to the use of micro-proppants in subterranean operations, and, more specifically, to self-consolidating micro-proppants, and methods of using these self-consolidating micro-proppants in subterranean operations.

After a wellbore is drilled, it may often be necessary to fracture the subterranean formation to enhance hydrocarbon production, especially in tight formations like shales and tight-gas sands. Access to the subterranean formation can be achieved by first creating an access conduit, such as a perforation, from the wellbore to the subterranean formation. Then, a fracturing fluid, often called a pad fluid, is introduced at pressures exceeding those required to maintain matrix flow in the formation permeability to create or enhance at least one fracture that propagates from at least one access conduit. The pad fluid is followed by a treatment fluid comprising a propping agent to prop the fracture open after pressure from the fluid is reduced. In some formations like shales, fractures can further branch into small fractures extending from a primary fracture giving depth and breadth to the fracture network created in the subterranean formation. As used herein, a “fracture network” refers to the access conduits, fractures, microfractures, and/or branches, man-made or otherwise, within a subterranean formation that are in fluid communication with the wellbore. As used herein, an “access conduit” refers to a passageway that provides fluid communication between the wellbore and the subterranean formation, which may include, but not be limited to, sliding sleeves, open holes in non-cased areas, hydrajetted holes, holes in the casing, perforations, and the like. The propping agents hold open the fracture network thereby maintaining the ability for fluid to flow through the fracture network to ultimately be produced at the surface.

Micro-proppants have proven their excellent performance in the shale and tight gas fracturing, particularly in the pad stage during unconventional shale fracturing. They provide improved connectivity between created and/or naturally occurring microfractures with generated primary fracture and hence significantly enhanced conductivity and well production. However, these micro-proppants are prone to flow back during production. Additionally, when they start migrating along the microfractures, they can block or reduce the flow paths leading to loss of conductivity of the primary fracture. When these particulates are entrained and migrate too near the wellbore region, they may severely impact production rate.

The degree of success of a hydraulic fracturing operation depends, at least in part, upon fracture conductivity after the fracturing operation has ceased and production commenced, creating the need for products and methods that control and or mitigate the flow back of micro-proppants and hence provide conductivity endurance.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIG. is a functionalized silica particle according to the prior art.

FIG. 2 depicts surface modified silica micro-particles functionalized with respective epoxy and amine groups.

FIG. 3 depicts the resulting chemical bond after combining the micro-particles in FIG. 2 and allowing them to react.

FIG. 4 depicts an embodiment of a system configured for delivering the immiscible fluid systems of the embodiments described herein to a downhole location.

FIGS. 5A-C depict various cores of self-consolidating micro-proppants after curing.

### DETAILED DESCRIPTION

Embodiments of this disclosure provide self-agglomerating micro-proppants for their use in unconventional shale formation fracturing applications. Surface functionalized self-agglomerating micro-proppant provides conductivity endurance in unconventional fracturing applications. The disclosure provides methods and processes to aid in avoiding, mitigating, and controlling the migration and flow back of micro-proppant and fines while maintaining desired conductivity.

As used herein, the term “microfracture” refers to a discontinuity in a portion of a subterranean formation creating a flow channel, the flow channel generally having a fracture width or flow opening size in the range of from about 1 μm to about 100 μm, and any size there between. The microfractures may be cracks, slots, channels, perforations, holes, or any other ablation within the formation.

Embodiments of the invention are directed to a well treatment method comprising placing a first stream comprising a base fluid, a first micro-proppant, and a second micro-proppant into a zone in a subterranean formation comprising microfractures, wherein the first micro-proppant comprises at least one functional group selected from amino groups, mercapto groups, carboxylates, vinyls, and combinations thereof, wherein the second micro-proppant comprises at least one functional group selected from acrylates, epoxies, isocyanates, oxazolines, vinyls, and combinations thereof; and allowing the first and second micro-proppants to self-consolidate. In an embodiment, at least one of the first micro-proppant, second micro-proppant, and combinations thereof are surface modified to accept the at least one functional group. The first micro-proppant may be surface modified using 3-Glycidyloxypropyl)trimethoxysilane (GPTMS). The second micro-proppant may be surface modified using at least one of N-[3-(Trimethoxysilyl)propyl]ethylenediamine (TMSPED), trimethoxysilyl propyl amine, and combinations thereof. At least one of the first micro-proppant, second micro-proppant, and combinations thereof may comprise fly ash. In another embodiment, the method further comprises placing non-functionalized micro-proppant into the zone. In a further embodiment, the method further comprises a low concentration resin in the first stream. The first micro-proppant and second micro-proppant may be present in a liquid gel concentrate before being placed into the zone. At least one of a pump, a mixer, and combinations thereof may be used for combining the components of the first stream and introducing the first stream into the wellbore.

In an embodiment, a well treatment method comprises combining a base fluid with a first micro-proppant, a second micro-proppant, and an agent for surface modifying the second micro-proppant to form a first fluid, wherein the first micro-proppant is surface modified and comprises at least one functional group, the second micro-proppant is non-functionalized, wherein the agent modifies the second micro-proppant to comprise at least one functional group that can form a covalent bond with the functional groups of the first micro-proppant; placing a first stream comprising the first fluid into a zone in a subterranean formation comprising microfractures; and allowing the first and second micro-proppants to self-consolidate. In one embodiment, the first micro-proppant comprises at least one functional group selected from amino groups, mercapto groups, carboxylates, vinyls, and combinations thereof. The functionalized second micro-proppant may comprise at least one functional group selected from acrylates, epoxies, isocyanates, oxazolines, vinyls, and combinations thereof. The first micro-proppant may be surface modified using 3-Glycidyloxypropyl)trimethoxysilane (GPTMS). In an embodiment, the agent may be at least one of N-[3-(Trimethoxysilyl)propyl]ethylenediamine (TMSPED), trimethoxysilyl propyl amine, and combinations thereof. In another embodiment, the agent is 3-Glycidyloxypropyl)trimethoxysilane (GPTMS). In yet another embodiment, the first micro-proppant is surface modified using at least one of N-[3-(Trimethoxysilyl)propyl]ethylenediamine (TMSPED), trimethoxysilyl propyl amine, and combinations thereof. At least one of the first micro-proppant, second micro-proppant, and combinations thereof may comprise fly ash. In another embodiment, the method further comprises placing non-functionalized micro-proppant into the zone.

In an embodiment, a well treatment method comprises: combining a base fluid with a first micro-proppant, a second micro-proppant, a first agent for surface modify the first micro-proppant, and a second agent for surface modifying the second micro-proppant to form a first fluid, wherein the first micro-proppant is initially non-functionalized and is modified by the first agent to comprise at least one functional group that can form a covalent bond with the functional groups of the second micro-proppant, the second micro-proppant is initially non-functionalized and is modified by the second agent to comprise at least one functional group that can form a covalent bond with the functional groups of the first micro-proppant; aggregating at least a portion the first and second functionalized micro-proppants into small clusters to form an aggregated first fluid; placing a first stream comprising the aggregated first fluid into a zone in a subterranean formation comprising microfractures. In one embodiment, the first micro-proppant comprises at least one functional group selected from amino groups, mercapto groups, carboxylates, vinyls, and combinations thereof. The functionalized second micro-proppant may comprise at least one functional group selected from acrylates, epoxies, isocyanates, oxazolines, vinyls, and combinations thereof. The first agent may be 3-Glycidyloxypropyl)trimethoxysilane (GPTMS). In an embodiment, the second agent may be at least one of N-[3-(Trimethoxysilyl)propyl]ethylenediamine (TMSPED), trimethoxysilyl propyl amine, and combinations thereof. At least one of the first micro-proppant, second micro-proppant, and combinations thereof may comprise fly ash. In another embodiment, the method further comprises placing non-functionalized micro-proppant into the zone.

In an embodiment, a micro-proppant composition comprises a first micro-proppant comprising at least one functional group selected from amino groups, mercapto groups, carboxylates, vinyls, and combinations thereof; and a second micro-proppant comprising at least one functional group selected from acrylates, epoxies, isocyanates, oxazolines, vinyls, and combinations thereof. In an embodiment, at least one of the first micro-proppant, second micro-proppant, and combinations thereof are surface modified to accept the at least one functional group. The first micro-proppant may be surface modified using 3-Glycidyloxypropyl)trimethoxysilane (GPTMS). The second micro-proppant may be surface modified using at least one of N-[3-(Trimethoxysilyl)propyl]ethylenediamine (TMSPED), trimethoxysilyl propyl amine, and combinations thereof.

In an embodiment, a well treatment method comprises placing a first stream comprising a base fluid, a first micro-proppant, and a second micro-proppant into a subterranean formation, wherein the first micro-proppant can self-consolidate with the second micro-proppant; and allowing the first and second micro-proppants to self-consolidate. In a further embodiment, the first stream is placed into a zone in the subterranean formation comprising microfractures. In an embodiment, the first micro-proppant may comprise at least one functional group selected from amino groups, mercapto groups, carboxylates, vinyls, and combinations thereof, and the second micro-proppant may comprise at least one functional group selected from acrylates, epoxies, isocyanates, oxazolines, vinyls, and combinations thereof. In an embodiment, at least one of the first micro-proppant, second micro-proppant, and combinations thereof are surface modified to accept the at least one functional group. The first micro-proppant may be surface modified using 3-Glycidyloxypropyl)trimethoxysilane (GPTMS). The second micro-proppant may be surface modified using at least one of N-[3-(Trimethoxysilyl)propyl]ethylenediamine (TMSPED), trimethoxysilyl propyl amine, and combinations thereof. At least one of the first micro-proppant, second micro-proppant, and combinations thereof may comprise fly ash. In another embodiment, the method further comprises placing non-functionalized micro-proppant into the zone. In a further embodiment, the method further comprises a low concentration resin in the first stream. The first micro-proppant and second micro-proppant may be present in a liquid gel concentrate before being placed into the zone.

Base Fluids

Suitable base fluids for use in conjunction with the present invention may include, but not be limited to, oil-based fluids; aqueous-based fluids; aqueous-miscible fluids; water-in-oil emulsions; or oil-in-water emulsions. Suitable oil-based fluids may include alkanes; olefins; aromatic organic compounds; cyclic alkanes; paraffins; diesel fluids; mineral oils; desulfurized hydrogenated kerosenes; and any combination thereof. Suitable aqueous-based fluids may include fresh water, saltwater (e.g., water containing one or more salts dissolved therein), brine (e.g., saturated salt water), seawater, and any combination thereof. Suitable aqueous-miscible fluids may include, but not be limited to, alcohols (e.g., methanol, ethanol, n-propanol, isopropanol, n-butanol, sec-butanol, isobutanol, and t-butanol; glycerins); glycols (e.g., polyglycols, propylene glycol, and ethylene glycol); polyglycol amines; polyols; any derivative thereof; any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate); any in combination with an aqueous-based fluid; and any combination thereof. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset there between. It should be noted that for water-in-oil and oil-in-water emulsions, any mixture of the above may be used including the water being and/or comprising an aqueous-miscible fluid. The base fluids for use in the present invention may additionally be gelled or foamed by any means known in the art.

The aqueous base fluids of the present embodiments can generally be from any source, provided that the fluids do not contain components that might adversely affect the stability and/or performance of the treatment fluids of the present invention.

Because of the high volume of fracturing fluid typically used in fracturing, it is desirable to increase the viscosity of fracturing fluids efficiently in proportion to the concentration of the viscosity-increasing agent. A viscosity-increasing agent is a chemical additive that alters fluid rheological properties to increase the viscosity of the fluid. Being able to use only a small concentration of the viscosity-increasing agent requires less total amount of the viscosity-increasing agent to achieve the desired fluid viscosity in a large volume of fracturing fluid. Efficient and inexpensive viscosity-increasing agents include water-soluble polymers such as guar gum. Other types of viscosity-increasing agents, such as viscoelastic surfactants, can also be used for various reasons, for example, in high-temperature applications.

The viscosity of a solution of a given concentration of guar gum or other viscosity-increasing agent can be greatly enhanced by cross-linking the viscosity-increasing agent. One example of a cross-linking agent is boric acid. A cross-linking agent can help increase the viscosity of a fluid for a given concentration of a viscosity-increasing agent. A “base gel” is a fluid that includes a viscosity-increasing agent, such as guar, but that excludes, for example, fluids that are typically referred to as “cross-linked gels” and “surfactant gels.”

In the aqueous based fluid embodiments, a variety of gelling agents may be used, including hydratable polymers that contain one or more functional groups such as hydroxyl, carboxyl, sulfate, sulfonate, amino, or amide groups. Suitable gelling agents typically comprise natural polymers, synthetic polymers, or a combination thereof. A variety of gelling agents can be used in conjunction with the methods and compositions of the present invention, including, but not limited to, hydratable polymers that contain one or more functional groups such as hydroxyl, cis-hydroxyl, carboxylic acids, derivatives of carboxylic acids, sulfate, sulfonate, phosphate, phosphonate, amino, or amide. In certain exemplary embodiments, the gelling agents may be polymers comprising polysaccharides, and derivatives thereof that contain one or more of these monosaccharide units: galactose, mannose, glucose, xylose, arabinose, fructose, glucuronic acid, or pyranosyl sulfate. Examples of suitable polymers include, but are not limited to, xanthan, guar, guar derivatives (such as hydroxypropyl guar, carboxymethyl guar, and carboxymethylhydroxypropyl guar), and cellulose derivatives (such as hydroxyethyl cellulose and carboxylmethyl hydroxy ethyl cellulose). Additionally, synthetic polymers and copolymers that contain the above-mentioned functional groups may be used. Examples of such synthetic polymers include, but are not limited to, polyacrylate, polymethacrylate, polyacrylamide, polyvinyl alcohol, and polyvinylpyrrolidone.

The aqueous base fluid may include aqueous linear gels, aqueous linear polysaccharide gels, aqueous linear guar gels, crosslinked aqueous base fluids, slick water, water, brine, viscoelastic surfactant solution, and combinations thereof.

Commercially available aqueous gels include, but are not limited to, Delta Frac™ fracturing fluid, a borate fracturing fluid; DeepQuest™ stimulation fluid, a weighted stimulation fluid; Hybor™ fluid, a delayed borate-crosslinked fluid using guar or hydroxypropyl gar gelling agent; OmegaFrac™ fluid system; pHaserFrac℠ Service fracturing fluid; Pur-Gel™III fracturing fluid; SeaQuest℠ Service fracturing fluid; Sirocco℠ Service fracturing fluid; SilverStim™ UR and LT fracturing fluid; Thermagel™ fluid; Versagel™ HT and LT system fluid, all of which are available from Halliburton Energy Services, Inc., Houston, Tex.

Micro-Proppants

The present disclosure utilizes micro-proppants and functionalized micro-proppants. Generally, micro-proppants are based on silica, fly ash, and/or other metal oxides (e.g., alumina oxide) (See US 20130284437). Typically, functionalization is performed using suitable silane based reactive components. Self-agglomerating micro-proppant can be obtained by functionalizing the silica/micro-particles surface when treated with reactive functional silanes by following standard protocols known in the literature. See Bioconjugate Chem. 2013, 24, 2076-2087.

Reactive groups capable of forming covalent chemical bonding between fine particles may include variety of chemical functionalities, and examples of their combinations are listed in Table 1.

TABLE 1
Reactive groups for functionalizing micro-proppants

| Functional group X | Functional group Y |
|---|---|
| Amino | Acrylates, Epoxy, Isocyanates |
| Mercapto | Epoxy, oxazoline |
| Carboxylates | Acrylates, Epoxy, Isocyanates, oxazoline |
| vinyl | vinyl |

The above mentioned functional groups may be attached on the surface of the micro-proppant using corresponding silane based chemical entities. These types of silane entities have already been used for fines/sand control to provide excellent consolidation strength to stop migration of such particles while providing significant regain permeability. (See US2014/0311740). In an embodiment, a method of treating a wellbore includes the use of silane functionalized micro-particles as self-agglomerating micro-proppant by aggregating a few micro-particles together to form minute clusters for unconventional fracturing applications. These micro-particles clusters may still be deformed under shear-stress to allow them to enter the microfractures without screening out at their entrances and keeping the created fissures open. In view of fines agglomeration, the required silane based chemicals should be pumped at very low concentration. Vinyl monomers may polymerize on their own upon reaching high temperatures such as those at the bottom of the hole. Combinations of two different types of vinyl monomers may react to form bonds, or a single type of vinyl monomer may react to form bonds between functionalized silane entities.

As an example, functionalized silica or other metal oxide micro-particles may be obtained by following standard protocol reported in Bioconjugate Chem. FIG. 1 is taken from this reference.

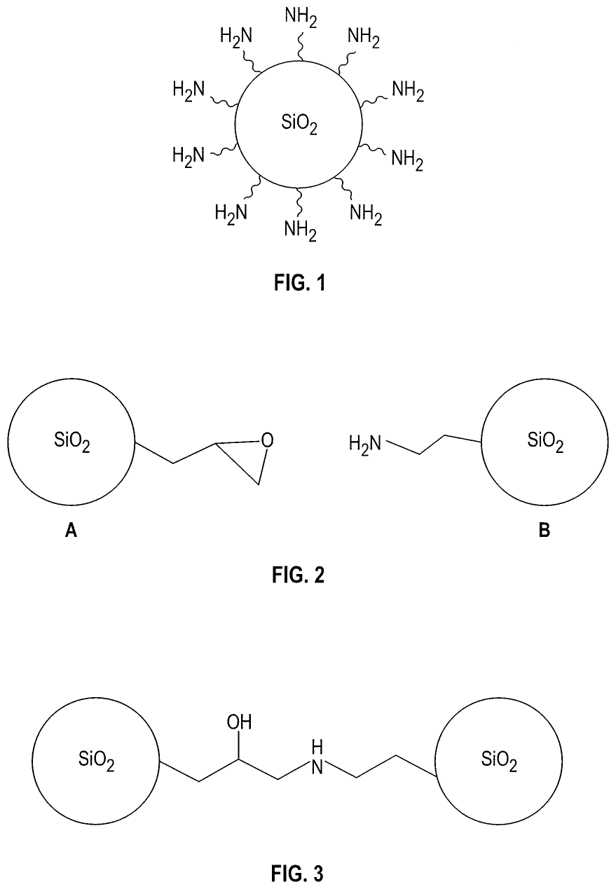

Reacting silica micro-particles with (3-Glycidyloxypropyl)trimethoxysilane (GPTMS) gives corresponding epoxy surface modified micro-particle A in FIG. 2. Similarly, using N-[3-(Trimethoxysilyl)propyl]ethylenediamine (TMSPED) or trimethoxysilyl propyl amine will produce respective amine functionalized micro-particle B in FIG. 2. Note that only a single functionality is shown on the surface of micro-particles A and B. In reality, much of the surface is functionalized with a large number of such reactive groups.

When micro-particles A and B of FIG. 2 are pumped together as micro-proppant, surface functionalities react under downhole conditions to form strong chemical bonds as shown in FIG. 3. This ultimately results in the self-agglomeration of micro-particles without affecting the permeability. Because of the large number of functionalities on the surface, the degree of crosslinking may be very high, thus producing a prominent micro-proppant cluster.

Although the above examples describe the self-agglomeration with epoxy and amine surface functionalized micro-proppant, a variety of other appropriate combination of functionalities as disclosed in Table 1 may also provide the desired results.

Creating Functionalized Micro-Proppants

The functionalized micro-proppant particulates of the present invention are coated with a functional agent to form at least a partial molecular layer. As used herein, the term “molecular layer” refers to the average thickness of a monolayer of molecules at least one molecular layer thick of a surface modification agent having a reactive site bonded to the surface of a micro-proppant particulate. A typical molecular layer may be from about 0.5 nanometers thick to about 800 nanometers thick. As used herein, the term “partial molecular layer” refers to a monolayer of molecules at least one molecular layer thick that does not fully cover or surround the entire outer surface of a micro-proppant particulate. The methods of the present invention are particularly advantageous because, although only a small quantity of functional agent is necessary to create the partial molecular layer on the micro-proppant particulates, the functionalized micro-proppant particulates are capable of accepting surface modification agents in a significantly more uniform and predictable manner than traditional micro-proppant particulates that have been conventionally treated with a surface modification agent and a coupling agent. Additionally, the functional agent may be designed such that the reactive site of the functional agent may either accept the surface modification agent alone or accept the surface modification agent and change the surface properties of the surface modification agent (e.g., creating a hydrophilic or hydrophobic surface).

In some embodiments, the molecular layer of the functional agent formed on the micro-proppant particulates of the present invention may be in the form of a partial or complete monolayer or a multilayer adsorption. In some embodiments, the functional agent formed on the micro-proppant particulates is in the range from about one to about ten molecular layers. In some preferred embodiments, the functional agent formed on the micro-proppant particulates is in the range from about three to about eight molecular layers. The molecular layers may be interconnected through a loose network structure, intermixed, or both. Application of the functional agent onto the micro-proppant particulates in order to create the functionalized micro-proppant particulates of the present invention may be performed by any technique capable of depositing the functional agent onto the micro-proppant particulates. In some embodiments, the functional agent is deposited onto the micro-proppant particulates of the present invention by spraying, atomizing, steady liquid stream, vapor phase deposition, or aerosol application. The functional agent may be deposited on the micro-proppant particulates prior to beginning a subterranean operation or on-the-fly during the subterranean operations.

Specific examples of suitable surface modifications agents for use in the present invention may include, but are not limited to, an epoxy; a furfuryl alcohol; a furan; a phenolic resin; a vinyl; a urethane; a polyurethane; an acrylate; a methacrylate; an unsaturated polyester; a polyethylene; a polypropylene; a polystyrene; a polycarbonate; an acrylic; a polyamide; a polydiene; a polyphenylene sulfide; a halogen-modified homopolymer; a chlorosulfonyl-modified homopolymer; any derivatives thereof; any copolymers thereof; an any combinations thereof. One of ordinary skill in the art, with the benefit of this disclosure, will recognize the type of surface modification agent to use for a particular subterranean operation. The choice of a surface modification agent may depend, at least in part, on the properties of the subterranean formation (e.g., pH, temperature, salinity, and the like) and the type of functional agent used. In some embodiments, the surface modification agent is present in the methods of the present invention in an amount from about 0.01% to about 10% by weight of the treatment fluid. In preferred embodiments, the surface modification agent is present in the methods of the present invention in an amount from about 0.1% to about 5% by weight of the treatment fluid.

Traditional micro-proppant particulates that have been treated with a surface modification agent and a coupling agent typically require that the coupling agent be present in an amount from about 0.1% to about 5% by weight of the micro-proppant particulates. The functional agent of the present invention may be coated onto the micro-proppant particulates to form a molecular layer in the range having an upper limit from about 0.5%, 0.4%, 0.3%, 0.2%, 0.1%, 0.09%, 0.08% by weight of the micro-proppant particulates to a lower limit from about 0.07%, 0.06%, 0.05%, 0.04%, 0.03%, 0.02%, 0.01%, 0.009%, 0.008%, 0.007%, 0.006%, 0.005%, 0.004%, 0.003%, 0.002%, 0.001%. In preferred embodiments, the functional agent of the present invention may be present in the range of about 0.01% to about 0.1% by weight of the micro-proppant particulates. Thus, as discussed previously, the methods of the present invention do not require a large amount of costly materials to coat the micro-proppant particulates in order to receive a surface modification agent. Suitable functional agents for use in the methods of the present invention may include, but are not limited to at least one of: an acrylate silane; a methacrylate silane; an aldehyde silane; an amino silane; a cyclic azasilane; an anhydride silane; an azide silane; a carboxylate silane; a phosphate silane; a sulfonate silane; an epoxy silane; an ester silane; a halogen silane; a hydroxyl silane; an isocyanate silane; a phospine silane; a sulfur silane; a vinyl silane; an olefine silane; a fluorinated alkyl-silane; any polymeric silane thereof; and any combination thereof. One of ordinary skill in the art, with the benefit of this disclosure, will recognize the type and amount of functional agent to include in the methods of the present invention for a particular subterranean operation depending on, for example, the properties of the subterranean formation, the type and size of micro-proppant particulates used, and/or the type of surface modification agent used.

Resins

The term “resin” as used herein refers to any of numerous physically similar polymerized synthetics or chemically modified natural resins including thermoplastic materials and thermosetting materials. Resins suitable for use in the present disclosure include all resins known and used in the art. One type of resin coating material suitable for use in the compositions and methods of the present disclosure is a two-component epoxy based resin comprising a liquid hardenable resin component and a liquid hardening agent component. The liquid hardenable resin component is comprised of a hardenable resin and an optional solvent. The solvent may be added to the resin to reduce its viscosity for ease of handling, mixing and transferring. It is within the ability of one skilled in the art with the benefit of this disclosure to determine if and how much solvent may be needed to achieve a viscosity suitable to the subterranean conditions. Factors that may affect this decision include geographic location of the well, the surrounding weather conditions, and the desired long-term stability of the consolidating agent emulsion. An alternate way to reduce the viscosity of the hardenable resin is to heat it. This method avoids the use of a solvent altogether, which may be desirable in certain circumstances. The second component is the liquid hardening agent component, which is comprised of a hardening agent, a silane coupling agent, a surfactant, an optional hydrolyzable ester for, among other things, breaking gelled fracturing fluid films on the micro-proppant particulates, and an optional liquid carrier fluid for, among other things, reducing the viscosity of the hardening agent component.

Examples of hardenable resins that can be used in the liquid hardenable resin component include, but are not limited to, organic resins such as bisphenol A diglycidyl ether resin, butoxymethyl butyl glycidyl ether resin, bisphenol A-epichlorohydrin resin, bisphenol F resin, polyepoxide resin, novolak resin, polyester resin, phenol-aldehyde resin, urea-aldehyde resin, furan resin, urethane resin, a glycidyl ether resin, other similar epoxide resins and combinations thereof. The hardenable resin used is included in the liquid hardenable resin component in an amount in the range of from about 5% to about 100% by weight of the liquid hardenable resin component. In some embodiments the hardenable resin used is included in the liquid hardenable resin component in an amount of about 25% to about 55% by weight of the liquid hardenable resin component. It is within the ability of one skilled in the art with the benefit of this disclosure to determine how much of the liquid hardenable resin component may be needed to achieve the desired results. Factors that may affect this decision include which type of liquid hardenable resin component and liquid hardening agent component are used.

Other Additives

In addition to the foregoing materials, it can also be desirable, in some embodiments, for other components to be present in the treatment fluid. Such additional components can include, without limitation, particulate materials, fibrous materials, bridging agents, weighting agents, gravel, corrosion inhibitors, catalysts, clay control stabilizers, biocides, bactericides, friction reducers, gases, surfactants, solubilizers, salts, scale inhibitors, foaming agents, anti-foaming agents, iron control agents, and the like.

Methods of Use

While conducting a fracturing operation, micro-proppants can either be pumped along with the pad fluid or can be pumped along with low viscosity fluid in alternate stages with high viscosity fluids carrying regular proppants. The fracturing operations results in forming at least a primary fracture propped open by regular conventional proppants and several branched secondary fractures or microfractures connected to the primary fracture and eventually to the wellbore propped open by micro-proppants.

A method of treating a well may include modifying micro-particle surfaces above ground before adding them into the fracturing fluid. Surface modification may be optimized to be performed onsite or the product may by commercially obtained. The cost is relatively inexpensive based on the price of chemicals and micro-proppant/particles required. Also, amounts of surface modifying chemicals required are significantly lower in comparison to regular resin coating (<0.1%) since embodiments of the present disclosure are directed to mono layer molecular coating. Surface modification may be achieved at the well site by mixing with appropriate silylating agents as required.

In an embodiment of this disclosure, an appropriate mixture of surface functionalized micro-proppant may be pumped in to the subterranean formation.

In another embodiment, surface functionalized micro-proppant may be alternatively pumped in stages with non-functionalized micro-proppant to further reduce the costs.

In yet another embodiment, mixture of functionalized micro-proppant may be pumped with a very low concentration of resin to provide a further improved consolidated proppant pack.

In an embodiment, surface modification of the micro-proppant is performed using one of the silylating agents (e.g., GPTMS) while the other silylating agent (e.g., TMSPED) is pumped with the carrier fluid.

In one embodiment, instead of injecting individual micro-particles, a low concentration of silane-based chemicals is included in the fracturing carrier fluid to treat the micro-particles and aggregate at least a portion of them into small clusters, such that they can still be placed inside the created fractures and microfractures to greatly enhance the conductivity of the propped fractures.

In another embodiment, surface modified micro-proppant is pumped in liquid gel concentrate to avoid issues of dust at well site.

The treatment fluids of the present invention may be prepared by any method suitable for a given application. For example, certain components of the treatment fluid of the present invention may be provided in a pre-blended powder or a dispersion of powder in a nonaqueous liquid, which may be combined with the aqueous base fluid at a subsequent time. After the preblended liquids and the aqueous base fluid have been combined, polymerization initiators and other suitable additives may be added prior to introduction into the wellbore. Those of ordinary skill in the art, with the benefit of this disclosure will be able to determine other suitable methods for the preparation of the treatments fluids of the present invention.

The methods of the present invention may be employed in any subterranean treatment where a viscoelastic treatment fluid may be used. Suitable subterranean treatments may include, but are not limited to, fracturing treatments, sand control treatments (e.g., gravel packing), and other suitable treatments where a treatment fluid of the present invention may be suitable.

In addition to the fracturing fluid, other fluids used in servicing a wellbore may also be lost to the subterranean formation while circulating the fluids in the wellbore. In particular, the fluids may enter the subterranean formation via lost circulation zones for example, depleted zones, zones of relatively low pressure, zones having naturally occurring fractures, weak zones having fracture gradients exceeded by the hydrostatic pressure of the drilling fluid, and so forth.

Wellbore and Formation

Broadly, a zone refers to an interval of rock along a wellbore that is differentiated from surrounding rocks based on hydrocarbon content or other features, such as perforations or other fluid communication with the wellbore, faults, or fractures. A treatment usually involves introducing a treatment fluid into a well. As used herein, a treatment fluid is a fluid used in a treatment. Unless the context otherwise requires, the word treatment in the term “treatment fluid” does not necessarily imply any particular treatment or action by the fluid. If a treatment fluid is to be used in a relatively small volume, for example less than about 200 barrels, it is sometimes referred to in the art as a slug or pill. As used herein, a treatment zone refers to an interval of rock along a wellbore into which a treatment fluid is directed to flow from the wellbore. Further, as used herein, into a treatment zone means into and through the wellhead and, additionally, through the wellbore and into the treatment zone.

As used herein, into a subterranean formation can include introducing at least into and/or through a wellbore in the subterranean formation. According to various techniques known in the art, equipment, tools, or well fluids can be directed from a wellhead into any desired portion of the wellbore. Additionally, a well fluid can be directed from a portion of the wellbore into the rock matrix of a zone.

In various embodiments, systems configured for delivering the treatment fluids described herein to a downhole location are described. In various embodiments, the systems can comprise a pump fluidly coupled to a tubular, the tubular containing the fracturing compositions, and any additional additives, disclosed herein.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluid to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluid to the high pressure pump. In such embodiments, the low pressure pump may “step up” the pressure of the treatment fluid before it reaches the high pressure pump.

In some embodiments, the systems described herein can further comprise a mixing tank that is upstream of the pump and in which the treatment fluid is formulated. In various embodiments, the pump (e.g., a low pressure pump, a high pressure pump, or a combination thereof) may convey the treatment fluid from the mixing tank or other source of the treatment fluid to the tubular. In other embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole.

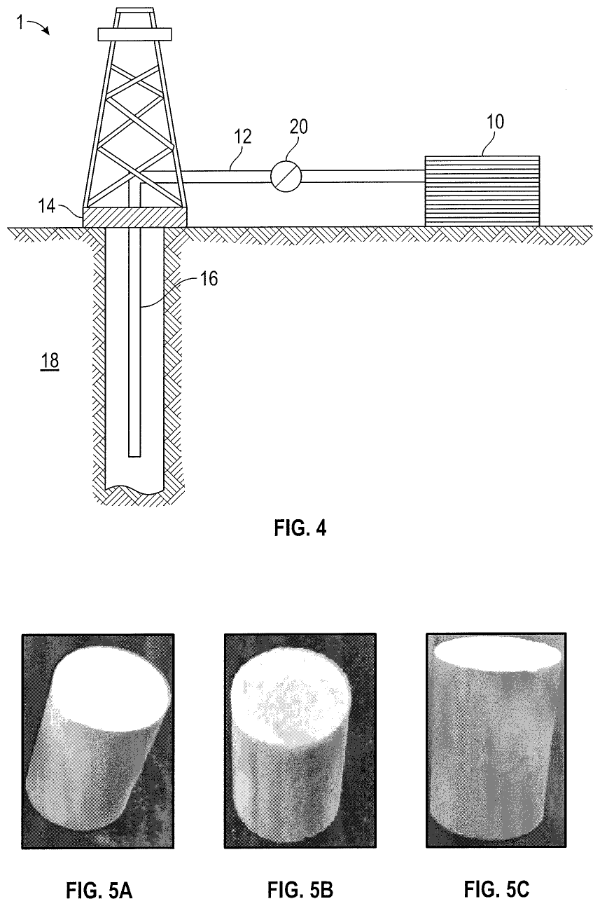

FIG. 4 shows an illustrative schematic of a system that can deliver treatment fluids of the embodiments disclosed herein to a downhole location, according to one or more embodiments. It should be noted that while FIG. 4 generally depicts a land-based system, it is to be recognized that like systems may be operated in subsea locations as well. As depicted in FIG. 4, system 1 may include mixing tank 10, in which a treatment fluid of the embodiments disclosed herein may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 4 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 4, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 4.

From the disclosure, one of skill in the art may realize that embodiments provide a method of monolayer coating of silane based coupling agents which can help in self-agglomeration of micro-particles without affecting the conductivity. Additionally, embodiments provide the ability to keep the created microfractures open, especially in the tight formations, to drastically enhance the conductivity of the microfractures in the complex fracture network, and improve the ultimate production of the well.

The invention having been generally described, the following examples are given as particular embodiments of the invention and to demonstrate the practice and advantages hereof. It is understood that the examples are given by way of illustration and are not intended to limit the specification or the claims to follow in any manner.

### EXAMPLES

### Experimental Procedure

One portion of micro-proppant/sand (SSA-1™ agent and separately SSA-2™ agent) was added to 3-Glycidyloxypropyl)trimethoxysilane (GPTMS) and another portion to N-[3-(Trimethoxysilyl)propyl]ethylenediamine (TMSPED). SSA-1™ agent (also called silica flour) is a powdered sand and SSA-2™ Strength-Stabilizing Agent (also called coarse silica flour) is Oklahoma No. 1 dry sand. It is coarser grind than SSA-1™ agent silica. Both are available from Halliburton Energy Services, Inc., Houston, Tex. Each was heated at 70° C. for 3 hours. Equal portions of amine and epoxy surface functionalized micro-proppant (functionalized SSA-1™ agents and separately functionalized SSA-2™ agents) were taken in a syringe and added with few drops of water, followed by curing in oven at 70° C. for 4 hours. A consolidated core was taken out and UCS (unconfined consolidation strength) was measured. The results were 250 psi for the cured SSA-1™ core and 130 psi for cured SSA-2™ core. The resulting cured cores are shown in FIG. 5A (SSA-1™), 5B (SSA-2™) and 5C (crushed core of SSA-1™).

Embodiments disclosed herein include:

A: A well treatment method comprising: placing a first stream comprising a base fluid, a first micro-proppant, and a second micro-proppant into a zone in a subterranean formation comprising microfractures, wherein the first micro-proppant comprises at least one functional group selected from amino groups, mercapto groups, carboxylates, vinyls, and combinations thereof, wherein the second micro-proppant comprises at least one functional group selected from acrylates, epoxies, isocyanates, oxazolines, vinyls, and combinations thereof; and allowing the first and second micro-proppants to self-consolidate.

B: A well treatment method comprising: combining a base fluid with a first micro-proppant, a second micro-proppant, and an agent for surface modifying the second micro-proppant to form a first fluid, wherein the first micro-proppant is surface modified and comprises at least one functional group, the second micro-proppant is non-functionalized, wherein the agent modifies the second micro-proppant to comprise at least one functional group that can form a covalent bond with the functional groups of the first micro-proppant; placing a first stream comprising the first fluid into a zone in a subterranean formation comprising microfractures; and allowing the first and second micro-proppants to self-consolidate.

C: A well treatment method comprising: combining a base fluid with a first micro-proppant, a second micro-proppant, a first agent for surface modify the first micro-proppant, and a second agent for surface modifying the second micro-proppant to form a first fluid, wherein the first micro-proppant is initially non-functionalized and is modified by the first agent to comprise at least one functional group that can form a covalent bond with the functional groups of the second micro-proppant, the second micro-proppant is initially non-functionalized and is modified by the second agent to comprise at least one functional group that can form a covalent bond with the functional groups of the first micro-proppant; aggregating at least a portion the first and second functionalized micro-proppants into small clusters to form an aggregated first fluid; placing a first stream comprising the aggregated first fluid into a zone in a subterranean formation comprising microfractures.

D: A micro-proppant composition comprising: a first micro-proppant comprising at least one functional group selected from amino groups, mercapto groups, carboxylates, vinyls, and combinations thereof; and a second micro-proppant comprising at least one functional group selected from acrylates, epoxies, isocyanates, oxazolines, vinyls, and combinations thereof.

E: A well treatment method comprising: placing a first stream comprising a base fluid, a first micro-proppant, and a second micro-proppant into a subterranean formation, wherein the first micro-proppant can self-consolidate with the second micro-proppant; and allowing the first and second micro-proppants to self-consolidate.

Each of embodiments A, B, C, D and E may have one or more of the following additional elements in any combination: Element 1: wherein at least one of the first micro-proppant, second micro-proppant, and combinations thereof are surface modified to accept the at least one functional group. Element 2: wherein the first micro-proppant is surface modified using 3-Glycidyloxypropyl)trimethoxysilane (GPTMS). Element 3: wherein the second micro-proppant is surface modified using at least one of N-[3-(Trimethoxysilyl)propy]lethylenediamine (TMSPED), trimethoxysilyl propyl amine, and combinations thereof. Element 4: wherein at least one of the first micro-proppant, second micro-proppant, and combinations thereof comprises fly ash. Element 5: further comprising placing non-functionalized micro-proppant into the zone. Element 6: further comprising a low concentration resin in the first stream. Element 7: wherein the first micro-proppant and second micro-proppant are in a liquid gel concentrate before being placed into the zone. Element 8: further comprising at least one of a pump, a mixer, and combinations thereof for combining the components of the first stream and introducing the first stream into the wellbore. Element 9: wherein the micro-proppant is sand. Element 10: wherein the vinyl group on the first micro-proppant is the same as the vinyl group on the second micro-proppant. Element 11: wherein the vinyl group on the first micro-proppant is different from the vinyl group on the second micro-proppant. Element 12: wherein the first micro-proppant comprises at least one functional group selected from amino groups, mercapto groups, carboxylates, vinyls, and combinations thereof. Element 13: wherein the functionalized second micro-proppant comprises at least one functional group selected from acrylates, epoxies, isocyanates, oxazolines, vinyls, and combinations thereof. Element 14: wherein the agent is least one of N-[3-(Trimethoxysilyl)propyl]ethylenediamine (TMSPED), trimethoxysilyl propyl amine, and combinations thereof. Element 15: wherein the agent is 3-Glycidyloxypropyl)trimethoxysilane (GPTMS). Element 16: wherein the first micro-proppant is surface modified using at least one of N-[3-(Trimethoxysilyl)propyl]ethylenediamine (TMSPED), trimethoxysilyl propyl amine, and combinations thereof. Element 17: wherein the first micro-proppant comprises at least one functional group selected from amino groups, mercapto groups, carboxylates, vinyls, and combinations thereof, and wherein the second micro-proppant comprises at least one functional group selected from acrylates, epoxies, isocyanates, oxazolines, vinyls, and combinations thereof. Element 18: wherein the first stream is placed into a zone in the subterranean formation comprising microfractures.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

1. A well treatment method comprising:
placing a first stream comprising a base fluid, a first micro-proppant, and a second micro-proppant into a zone in a subterranean formation comprising microfractures, wherein the first micro-proppant comprises at least one functional group selected from the group consisting of amino groups, mercapto groups, carboxylates, vinyls, and combinations thereof, wherein the second micro-proppant comprises at least one functional group selected from the group consisting of acrylates, epoxies, isocyanates, oxazolines, vinyls, and combinations thereof; and
allowing the first and second micro-proppants to self-consolidate.

2. The method of claim 1, wherein at least one of the first micro-proppant, second micro-proppant, and combinations thereof are surface modified to accept the at least one functional group.

3. The method of claim 2, wherein the first micro-proppant is surface modified using 3-Glycidyloxypropyl)trimethoxysilane (GPTMS).

4. The method of claim 2, wherein the second micro-proppant is surface modified using at least one agent selected from the group consisting of N-[3-(Trimethoxysilyl)propyl]ethylenediamine (TMSPED), trimethoxysilyl propyl amine, and combinations thereof.

5. The method of claim 1, wherein at least one of the first micro-proppant, second micro-proppant, and combinations thereof comprises fly ash.

6. The method of claim 1, further comprising placing non-functionalized micro-proppant into the zone.

7. The method of claim 1, further comprising a low concentration resin in the first stream.

8. The method of claim 1, wherein the first micro-proppant and second micro-proppant are in a liquid gel concentrate before being placed into the zone.

9. The method of claim 1, further comprising at least one of a pump, a mixer, and combinations thereof for combining the components of the first stream and introducing the first stream into the wellbore.

10. A well treatment method comprising:
combining a base fluid with a first micro-proppant, a second micro-proppant, and an agent for surface modifying the second micro-proppant to form a first fluid, wherein the first micro-proppant is surface modified and comprises at least one functional group, the second micro-proppant is non-functionalized, wherein the agent modifies the second micro-proppant to comprise at least one functional group that can form a covalent bond with the functional groups of the first micro-proppant;
placing a first stream comprising the first fluid into a zone in a subterranean formation comprising microfractures; and
allowing the first and second micro-proppants to self-consolidate.

11. The method of claim 10, wherein the first micro-proppant comprises at least one functional group selected from the group consisting of amino groups, mercapto groups, carboxylates, vinyls, and combinations thereof.

12. The method of claim 10, wherein the functionalized second micro-proppant comprises at least one functional group selected from the group consisting of acrylates, epoxies, isocyanates, oxazolines, vinyls, and combinations thereof.

13. The method of claim 11, wherein the first micro-proppant is surface modified using 3-Glycidyloxypropyl)trimethoxysilane (GPTMS).

14. The method of claim 10, wherein the agent is least one agent selected from the group consisting of N-[3-(Trimethoxysilyl)propyl]ethylenediamine (TMSPED), trimethoxysilyl propyl amine, and combinations thereof.

15. The method of claim 10, wherein the agent is 3-Glycidyloxypropyl)trimethoxysilane (GPTMS).

16. The method of claim 10, wherein the first micro-proppant is surface modified using at least one chemical selected from the group consisting of N-[3-(Trimethoxysilyl)propyl]ethylenediamine (TMSPED), trimethoxysilyl propyl amine, and combinations thereof.

17. The method of claim 10, wherein at least one of the first micro-proppant, second micro-proppant, and combinations thereof comprises fly ash.

18. The method of claim 10, further comprising placing non-functionalized micro-proppant into the zone.

19. (canceled)

20. A micro-proppant composition comprising:
a first micro-proppant surface modified to comprise at least one functional group selected from the group consisting of amino groups, mercapto groups, carboxylates, vinyls, and combinations thereof; and
a second micro-proppant surface modified to comprise at least one functional group selected from the group consisting of acrylates, epoxies, isocyanates, oxazolines, vinyls, and combinations thereof.

21. (canceled)

22. The composition of claim 20, wherein the first micro-proppant is surface modified using 3-Glycidyloxypropyl)trimethoxysilane (GPTMS) and wherein the second micro-proppant is surface modified with an agent is selected from the group consisting of N-[3-(Trimethoxysilyl)propyl]ethylenediamine (TMSPED), trimethoxysilyl propyl amine, and combinations thereof.

23.-33. (canceled)
